(19) United States
(12) Patent Application Publication
(10) Pub. No.: US 2016/0156175 A1
(43) Pub. Date: Jun. 2, 2016

(54) CURRENT-LIMITING REACTOR APPARATUS

(71) Applicant: KABUSHIKI KAISHA TOSHIBA, Minato-ku, Tokyo (JP)

(72) Inventors: Tadashi KOSHIZUKA, Saitama (JP); Yoshiaki OHDA, Yokohama (JP); Masayuki SATO, Yokohama (JP); Yuki MATSUI, Ota (JP)

(73) Assignee: KABUSHIKI KAISHA TOSHIBA, Minato-ku, Tokyo (JP)

(21) Appl. No.: 14/905,493

(22) PCT Filed: Mar. 26, 2014
(86) PCT No.: PCT/JP2014/058613

§ 371 Date: Jan. 15, 2016

(30) Foreign Application Priority Data
Aug. 1, 2013 (JP) 2013-160150

(51) Int. Cl. H02H 9/02; H02M 1/32

(52) U.S. Cl. CPC H02H 9/02; H02M 1/32

(57) ABSTRACT

A current-limiting reactor that is capable of decreasing an increase rate of a fault current without increasing a handling energy by a surge absorber of a DC breaker provided in a DC system. A current-limiting reactor apparatus includes a reactor connected in series with a DC breaker, a surge absorber connected in parallel with the reactor, and a switch connected in series with the surge absorber. The switch is loaded before the DC breaker cuts off a current and after a fault occurs in a power system.

### TECHNICAL FIELD

Embodiments of the present disclosure relate to a current-limiting reactor apparatus that is connected in series with a DC breaker in a power system.

### BACKGROUND ART

DC power transmission by high voltage is now getting attention since power losses inherent to power transmission are little in comparison with AC power transmission and this scheme remarkably decreases costs for lines and cables. Hence, this scheme is applied in many locations. In addition, application of DC power transmission is also encouraged by widespread utilization of a power supply that utilizes natural energy, such as solar light and wind power, and a DC-output type distributed power supply, such as a micro-gas turbine and a fuel cell.

DC power transmission is based on a DC multi-terminal power distribution system that is capable of directly supplying DC power from the distributed power supply to the DC load, and it is necessary to develop a converter and a DC breaker, the converter converts voltage levels of a load, a distributed power supply and a voltage level of a DC power distribution system, and the DC breaker protects the load and the distributed power supply.

With respect to the converter, a self-excited converter which includes self-extinguishing type semiconductor switching elements like IGBTs, and which is controlled by PWM control has a large number of advantages in DC power transmission in comparison with a separately-excited converter. Hence, the self-excited converter has a high degree of expectation. A DC breaker includes a surge absorber which restricts a voltage across contacts and which is connected in parallel with the contacts so as to suppress an insulation breakdown due to an overvoltage across the contacts (see, for example, Non-Patent Document 1).

### CITATION LIST

### Non-Patent Literature

Non-Patent Document 1: JURGEN HAFNER, BJORN JACOBSON “Proactive Hybrid HVDC Breakers—A key innovation for reliable HVDC grids” CIGRE International Symposium in Bologna, 2011

Constant voltage control is applied to the self-excited converter. Hence, when a fault occurs in the DC system, the self-excited converter increases an output current so as to maintain a rated value. Consequently, a fault current increases. This fault current has an increase time constant that is given by the inductance and resistance of the system between a power supply and a fault point.

Hence, in order to prevent the fault current from exceeding a rated breaking capacity of the DC breaker, according to the Non-Patent Document 1, a current-limiting reactor is connected in series with the DC breaker to suppress an increase of the fault current. This current-limiting reactor has an inductance that is several hundred mH.

When the inductance of the current-limiting reactor is large, the increase rate of the fault current is actually decreased. When, however, the inductance of the current-limiting reactor is large, it is necessary for the surge absorber of the DC breaker to handle induction energy accumulated by the current-limiting reactor, and thus the handling energy for the surge absorber of the DC breaker becomes large.

A current-limiting reactor apparatus according to embodiments has been made to address the aforementioned technical problems, and it is an objective of the present disclosure to provide a current-limiting reactor apparatus that is capable of decreasing an increase rate of a fault current without increasing a handling energy for a surge absorber of a DC breaker provided in a DC system.

### Solution to Problem

In order to accomplish the above objective, a current-limiting reactor apparatus according to an embodiment includes a reactor connected in series with a DC breaker, a surge absorber connected in parallel with the reactor, and a switch connected in series with the surge absorber.

The reactor may include a first coil of a single-phase transformer connected in series with the DC breaker, and the surge absorber may be connected in series with a second coil of the single-phase transformer. The switch may be loaded before the DC breaker breaks a current and after a fault occurs in a power system.

### BRIEF DESCRIPTION OF DRAWINGS

FIG. 1 is a structural diagram illustrating a current-limiting reactor apparatus and a connection scheme therewith according to a first embodiment;

FIGS. 2A to 2D are each a waveform diagram illustrating an operation of a DC breaker and that of a switch of the current-limiting reactor apparatus when the DC breaker breaks a DC current after a fault occurs, and FIG. 2A illustrates a breaker-unit current of the DC breaker and a surge-absorber current, FIG. 2B illustrates a voltage across electrodes of the DC breaker, FIG. 2C illustrates a handling energy of a surge absorber of the DC breaker, and FIG. 2D illustrates a handling energy of a surge absorber of the current-limiting reactor apparatus; and

FIG. 3 is a structural diagram illustrating a current-limiting reactor apparatus and a connection scheme therewith according to a second embodiment.

### DESCRIPTION OF EMBODIMENTS

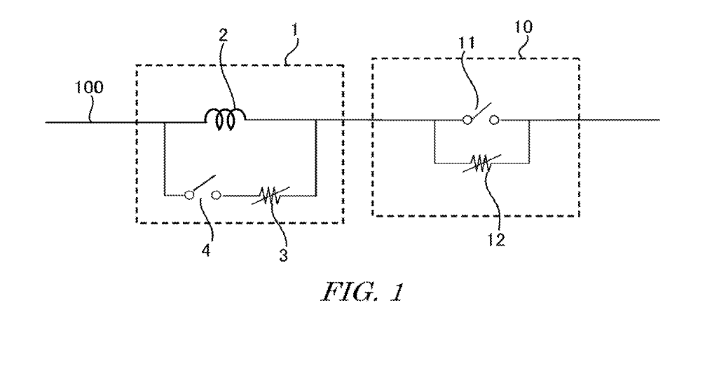

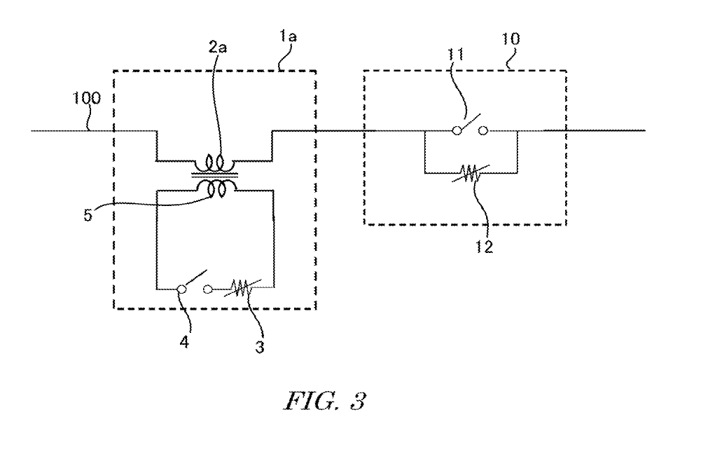

A current-limiting reactor apparatus according to several embodiments will be explained with reference to FIGS. 1 to 3. The term current-limiting reactor apparatus means various apparatuses that include a coil connected in series with a main circuit, and for example, a transformer that includes a coil in the main circuit is also considerable as the current-limiting reactor apparatus.

### First Embodiment

### Structure

As illustrated in FIG. 1, a current-limiting reactor apparatus 1 according to this embodiment is disposed in a main circuit 100 together with a DC breaker 10. The DC breaker 10 includes a breaker unit 11 on the main circuit 100, and also a surge absorber 12 connected in parallel with the breaker unit 11. The current-limiting reactor apparatus 1 include a current-limiting reactor 2, a surge absorber 3, and a switch 4.

The current-limiting reactor 2 is inserted in the main circuit 100 connected with the DC breaker 10, and is connected in series with the DC breaker 10. The surge absorber 3 is connected in parallel with the current-limiting reactor 2. The switch 4 is connected in parallel with the current-limiting reactor 2, and is connected in series with the surge absorber 3.

This current-limiting reactor 2 is located on the main circuit 100 to which DC power is supplied, and decreases the increase rate of a fault current, thereby improving the current break performance of the DC breaker 10. However, a magnetic field is generated by the fault current, and induction energy is accumulated.

The surge absorbers 3, 12 are each also called an arrester, and absorb the energy of a fault current. The surge absorber 12 of the DC breaker 10 is actuated when a voltage across the contacts of the DC breaker 10 exceeds a limit voltage, commutates the fault current, and absorbs the energy thereof, thereby reducing the voltage across the contacts of the DC breaker 10 to the limit voltage, and suppressing an insulation breakdown of the contact.

A mechanical or semiconductor switch, etc., is applicable as the switch 4 that opens or closes a circuit reaching the surge absorber 3 of the current-limiting reactor apparatus 1, and controls a flow-in of the fault current to the surge absorber 3. This switch 4 is loaded until the DC breaker 10 breaks the current after the fault occurs in the power system.

For example, the current-limiting reactor apparatus 1, the DC breaker 10, or other power equipment includes a detector that detects the fault current, and a detection signal from this detector is taken as a loading command signal to the switch 4. When the switch 4 is a semiconductor switch, it is appropriate if, for example, the detection signal is input to the gate.

(Action)

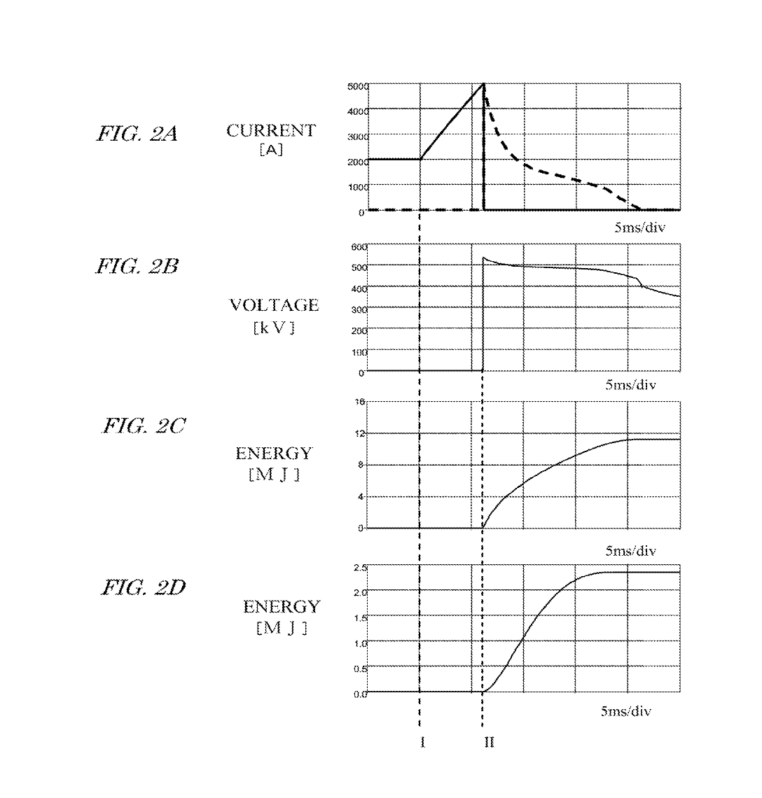

FIGS. 2A to 2D each illustrate an action of such a current-limiting reactor apparatus 1. As is indicated by a continuous line in FIG. 2A, when a fault occurs in the power system at a fault time point I, a current that flows the breaker unit 11 of the DC breaker 10 increases at a time constant which is given by an inductance and a resistance both between a power supply and a fault location. The current-limiting reactor 2 of the current-limiting reactor apparatus 1 suppress an increase of this current.

Subsequent to the fault time point I, at a given time point II, the DC breaker 10 breaks the current by the breaker unit 11. In addition, after the fault time point I, the current-limiting reactor apparatus 1 loads the switch 4 prior to this time point II, and commutates the current to the surge absorber 3 of the current-limiting reactor apparatus 1.

At this current-breaking time point II, as is indicated by a continuous line in FIG. 2A, a current that flows through the breaker unit 11 becomes zero. In addition, as illustrated in FIG. 2B, after the current-breaking time point II, a limit voltage across the electrodes of the breaker unit 11 appears. At this time, since the switch 4 has been already loaded, as is indicated by a dotted line in FIG. 2A, instead of the path that is through the breaker unit 11, a current appears in a path that reaches the surge absorber 12 of the DC breaker 10 through the surge absorber 3 of the current-limiting reactor apparatus 1.

As is indicated by a dotted line in FIG. 2A, this current is absorbed by both surge absorbers 3, 12, and eventually becomes zero. The energy of this current is, as illustrated in FIG. 2C that shows a handling energy by the surge absorber 12 of the DC breaker 10 and FIG. 2D that shows a handling energy by the surge absorber 3 of the current-limiting reactor apparatus 1, shared and handled by the surge absorber 3 of the current-limiting reactor apparatus 1 and the surge absorber 12 of the DC breaker 10.

That is, by providing the current-limiting reactor 2, although the entire handling energy increases by the induction energy accumulated by the current-limiting reactor 2, the surge absorber 3 of the current-limiting reactor apparatus 1 shares and handles such energy. Hence, the energy to be handled by the surge absorber 12 of the DC breaker 10 decreases.

(Effects)

As explained above, the current-limiting reactor apparatus 1 according to the first embodiment includes the current-limiting reactor 2 that is connected in series with the DC breaker 10, the surge absorber 3 that is connected in parallel with the current-limiting reactor 2, and the switch 4 that is connected in series with the surge absorber 3.

According to this circuit structure, the energy that the surge absorbers 3, 12 should handle due to a fault in the power system increases by the provided current-limiting reactor 2, but is shared and handled by the surge absorber 3 of the current-limiting reactor apparatus 1. Hence, the increase rate of a fault current is decreased by the current-limiting reactor 2 without increasing the energy to be handled by the surge absorber 12 of the DC breaker 10, in other words, without a need for increasing the dimension of the surge absorber 12.

### Second Embodiment

A current-limiting reactor apparatus 1 according to a second embodiment is a single-phase transformer 1a. In a pair of coils 2a, 5 of the single-phase transformer 1a, the one coil 2a has both ends connected with the main circuit 100, thus also serving as the current-limiting reactor 2. The switch 4 and the surge absorber 3 are provided within a circuit where the other coil 5 is disposed, and are connected in series with the other coil 5.

According to this single-phase transformer 1a, also, after the fault time point I, at the given time point II, the DC breaker 10 breaks the current, and after the fault time point I and before the time point II, the switch 4 is loaded. Hence, the energy is shared and handled by the surge absorber 3 of the current-limiting reactor apparatus 1 and the surge absorber 12 of the DC breaker 10.

According to this single-phase transformer 1a, since the switch 4 and the surge absorber 3 are connected with the circuit which is different from the main circuit 100, and which is connected with the coil 5, the switch 4 and the surge absorber 3 are enabled to have a different insulation level from that of the main circuit 100.

### Other Embodiments

Several embodiments according to the present disclosure were explained in this specification, but those embodiments are merely presented as examples, and are not intended to limit the scope of the present disclosure. All of or some of the structures disclosed in the respective embodiments may be combined, and such a combination is also within the scope of the present disclosure. The above respective embodiments can be carried out in other various forms, and various omissions, replacements, and modifications can be made thereto without departing from the scope of the present disclosure. Such embodiments and modified forms thereof are within the scope and spirit of the present disclosure, and also within the scope of the invention as recited in appended claims and the equivalent range thereto.

### REFERENCE SIGNS LIST

Current-limiting reactor apparatus
1a Single-phase transformer
2 Current-limiting reactor
2a Coil
3 Surge absorber
4 Switch
5 Coil
10 DC breaker
11 Breaker unit
12 Surge absorber
100 Main circuit

1. A current-limiting reactor apparatus comprising:
a reactor connected in series with a DC breaker;
a surge absorber connected in parallel with the reactor; and
a switch connected in series with the surge absorber.

2. The current-limiting reactor apparatus according to claim 1, wherein:
the reactor comprises a first coil of a single-phase transformer connected in series with the DC breaker; and
the surge absorber is connected in series with a second coil of the single-phase transformer.

3. The current-limiting reactor apparatus according to claim 1, wherein the switch is loaded before the DC breaker breaks a current and after a fault occurs in a power system.

4. The current-limiting reactor apparatus according to claim 2, wherein the switch is loaded before the DC breaker breaks a current and after a fault occurs in a power system.
